(19) United States
(12) Patent Application Publication
(10) Pub. No.: US 2023/0319969 A1
(43) Pub. Date: Oct. 5, 2023

(54) MONITORING OF X-RAY TUBE

(71) Applicant: KONINKLIJKE PHILIPS N.V., EINDHOVEN (NL)

(72) Inventors: WALTER RUETTEN, LINNICH (DE); CAROLINA MARIA RIBBING, AACHEN (DE)

(21) Appl. No.: 18/024,865

(22) PCT Filed: Sep. 2, 2021
(86) PCT No.: PCT/EP2021/074218

§ 371 Date: Mar. 6, 2023

(30) Foreign Application Priority Data
Sep. 8, 2020 (EP) 20194960.9

(51) Int. Cl. H05G 1/54

(52) U.S. Cl. CPC H05G 1/54

(57) ABSTRACT

The invention relates to an optical monitoring system (200) for monitoring an X-ray tube (100), the optical monitoring system (200) comprising: at least one optical sensor (201) configured to detect first signals of a first optical parameter and second signals of a second optical parameter thereby generating measurement data, wherein the first and second optical parameters are selected from the group comprising plasma glow, discharges, micro-discharges, arcs, x-ray fluorescence, line emissions, wherein the first and second optical parameters are different from each other, the optical monitoring system (200) further comprising a computing unit (202) configured to transmit, to a remote system (300) external of optical monitoring system (200) and the X-ray tube (100), said generated measurement data and/or a result of an analysis of measurement data carried out by the computing unit (202). The invention further relates to a unit comprising an X-ray tube (100) and such an optical monitoring system (200), as well as to a method (400) for monitoring an X-ray tube (100).

### FIELD OF THE INVENTION

The present invention relates to monitoring an X-ray tube, and in particular to an optical monitoring system for monitoring an X-ray tube, a unit comprising an X-ray tube and an optical monitoring system, a method for monitoring an X-ray tube and a program element.

### BACKGROUND OF THE INVENTION

X-ray tubes are often used in high-duty schedules, e.g. in medical imaging applications, and are subject stringent reliability requirements. Thus, ensuring rapid tube replacement in case of failure is of particular importance. However, prediction of failure time of an X-ray tube is imprecise and vague, such that procedures for tube replacement, particularly in medical imaging applications, are mainly reactionary, which means, a healthcare facility using the imaging application and an imaging application service organization get aware of failures only as they occur. This causes unplanned downtime which is associated with patient rescheduling and large costs.

### SUMMARY OF THE INVENTION

There may, therefore, be a need for improved prediction of failure time of an X-ray tube, particularly in case that no log data from the X-ray tube is available. The object of the present invention is solved by the subject-matter of the appended independent claims, wherein further embodiments are incorporated in the dependent claims.

According to a first aspect, there is provided an optical monitoring system for monitoring an X-ray tube. The optical system comprises at least one optical sensor and a computing unit. The at least one optical sensor is configured to detect first signals of a first optical parameter and second signals of a second optical parameter thereby generating measurement data. The first and second optical parameters are selected from the group comprising plasma glow, discharges, micro-discharges, arcs, x-ray fluorescence, line emissions, wherein the first and second optical parameters are different from each other. The computing unit is configured to transmit, to a remote system external of the X-ray tube and the optical monitoring system, said generated measurement data and/or a result of an analysis of measurement data carried out by the computing unit.

In other words, there is provided an optical monitoring system for monitoring an X-ray tube, comprising at least one optical sensor and a computing unit. The at least one optical sensor is configured to detect first signals of a first optical parameter and second signals of a second optical parameter thereby generating measurement data. The first and second optical parameters are by-products and/or side-effects of an electron beam and/or emitted X-ray radiation generated by the X-ray tube, wherein the first and second optical parameters are different from each other. The computing unit is configured to analyze said generated measurement data and to transmit said generated measurement data and/or a result of an analysis of measurement data carried out by the computing unit to a remote system external of the X-ray tube and the optical monitoring system.

In particular, the first and second optical parameters describe optical characteristics of by-products and/or side-effects of an electron beam and/or emitted X-ray radiation by the X-ray tube.

Such optical monitoring system can allow reliably predicting a remaining lifetime of an X-ray tube based on the generated measurement data. Based on the predicted remaining lifetime, a replacement of the X-ray tube may be planned to optimize the operation time and availability of a system in which the X-ray tube is installed. Log data often contains information relevant for lifetime prediction of the X-ray tube, for example, X-ray tube voltage, anode current, filament current, filament voltage, duration of X-ray pulse delivered, and/or events like arcing. When log data is not accessible, these parameters need to be monitored otherwise. Even when some log data is accessible, monitoring of additional parameters may increase the coverage of monitoring, improving the reliability of prediction of the remaining X-ray tube lifetime. The optical monitoring system provided may allow a reliable prediction of the remaining lifetime of the X-ray tube, when no log data are accessible. The system provided may also be used in tube conditioning during manufacturing, delivering data for process monitoring and, e.g. in an Industry 4.0 setting. The system provided may also be used by the service organization in a remote diagnostics setting.

The optical sensor as used herein, is to be understood as comprising at least one component being capable of detecting at least two optical parameters or as comprising two or more components, each of which being capable of detecting one optical parameter. Examples for optical sensors and/or components may be photodiodes, avalanche photodiodes, single-photon avalanche diodes, silicon photomultipliers, complementary metal-oxide-semiconductors (CMOS) and/or charge-coupled device (CCD) camera sensors, photomultipliers, optical gratings, lenses, color filters, spectrometers, and/or combinations thereof.

The computing unit is to be understood as a component being configured to at least allow transmitting the generated measurement data to a remote system external from the optical monitoring system. Further, the computing unit may be configured to analyze the generated measurement data and to additionally or alternatively transmit a result of the analysis of the generated measurement data. Transmitting the result of the analysis may comprise only transmitting the result without any interpretation of it or transmitting the result including an interpretation, e.g., informing the remote system that a replacement of the X-ray tube will be needed soon, such that a replacement of the X-ray tube may be planned well in advance to minimize the downtime of the application using the X-ray tube.

The remote system may be a locally placed remote system, such as a remote system outside the optical monitoring system and an imaging application using the X-ray tube but within the facility using the imaging application. Alternatively, the remote system may be a global system, such as a remote system being installed in an imaging application service center.

The optical monitoring system may further be used to assist in tube failure or tube deterioration diagnostics. These diagnostics may be performed either remotely, e.g. almost in real-time, or after the tube has been returned to the factory for diagnosis and refurbishing.

Additionally, the system may support usage monitoring, namely monitoring how customers, e.g. healthcare facilities, radiologists, and physicians, use the X-ray tube.

According to a particular embodiment, the first and second optical parameters may be selected from the group consisting of plasma glow, discharges, micro-discharges, arcs, x-ray fluorescence, line emissions. In other words, the first and second optical parameters may describe optical characteristics of at least one of plasma glow, discharges, micro-discharges, arcs, x-ray fluorescence, and line emissions. Additionally, or alternatively, also parameters of non-mentioned by-products and/or side-effects may be used.

According to an embodiment, the first parameter and the second parameter may exclude X-ray radiation and the first signals and the second signals may exclude X-ray radiation signals.

Thus, the first and second parameter may only comprise by-products and/or side-effects of the electron beam and/or X-ray radiation generated by the X-ray tube, preferable those showing a deviation and/or change in their characteristics that allow drawing conclusion on the remaining lifetime of the X-ray tube.

According to an embodiment, an X-ray tube lifetime model comprising at least one predefined pattern for tube status and/or tube aging may be stored in the computing unit, and the computing unit may be configured to use said stored X-ray tube lifetime model for analyzing said detected first signals and said detected second signals.

The X-ray tube lifetime model may correspond to a mathematical model relating the generated measurement data with the at least one predefined pattern. The X-ray tube lifetime model may deliver a remaining lifetime of the monitored X-ray tube as a result. The lifetime model may be based on the identification and/or the interpretation of patterns being characteristic of various impending failure modes of X-ray tubes. The mathematical model may be implemented in software as an algorithm.

According to an embodiment, the predefined pattern may comprise at least one event and/or at least one process and/or at least one predefined range and/or at least one threshold being indicative for tube age and/or tube wear status and/or tube vacuum status.

The pattern may correspond to a collection of at least one, preferably more than one value from the group of at least one event, at least one process, at least one predefined range, and at least one threshold, allowing to draw conclusions on tube age and/or tube wear status and/or tube vacuum status. The tube lifetime model can be based on a pattern of events/measurements detected in failing tubes.

According to an embodiment, the optical sensor may be configured to detect line emissions from at least one of the chemical elements B, Si, Na, K, Ca, Sr, Mg, 0, N, H, W, Re, Rh, Ga, In, Sn, Mo, Ni, Co, Be, Al, and Fe, as first signal.

Those line emissions are by-products of the emitted X-ray radiation and/or excitation by the electron beam and show characteristic changes, e.g., in behavior, intensity of occurrence, frequency of occurrence, and the like, depending on the remaining lifetime of the X-ray tube. Therefore, by monitoring line emission of at least one of the chemical elements mentioned above assists in a prediction of a remaining lifetime of the X-ray tube. For example, those signals may be used as measure of tube vacuum, for arc prediction and characterization for predicting of tube failures, e.g. due to vacuum leak, arc breakdown, and/or metal bearing deterioration. For example, line emissions can be kind of a pre-cursor to an arc. When these, preferably predefined, line emissions are detected, this means that there are vacuum problems. Of too much of these line emissions are inside the vacuum, this could lead to an ionized plasma, which effectively shorts out the anode voltage. Due to a large discharge current occurring at that moment, the plasma will get extremely hot and hence, will be emitting a lot of light, recognizable as a flash.

According to an embodiment, the optical monitoring system may additionally comprise at least one non-optical sensor configured to detect signals of at least one non-optical parameter. The non-optical sensor may preferably be a microphone and/or an accelerometer configured to detect sound and sound changes, an accelerometer to detect acceleration and/or position, a field coil configured to detect electromagnetic signals, and/or a radiation sensor, such as a scintillator plus photodiode, a solid state detector, a MOSFET, or an ionization gauge configured to monitor a tube output dose and/or spectrum.

The microphone and/or the accelerometer may allow capturing, e.g., changes in noise from bearings and/or sound from discharges and arcs. Analyzing those signals in the time and frequency domain may serve to pinpoint impending mechanical failures, e.g. bearing failures, imbalance of anode disk, and the like. The field coil may allow detecting electromagnetic signals, e.g. from arcs, discharges, drive frequencies and/or duty cycles. The radiation sensor allows monitoring tube output dose. The radiation sensor may be energy integrating or energy resolving. An energy resolving radiation sensor may allow determining focal track aging and simultaneously may allow monitoring of the X-ray spectrum and indirect monitoring of the tube voltage through measurement of the highest apparent photon energy. In combination with the measured dose and time stamping, a complete usage profile may be derived from an energy resolving radiation sensor.

According to an embodiment, the optical monitoring system may further comprise at least one additional optical sensor. The additional optical sensor may be an optical grating in combination with a number of photodiodes, wherein the number of photodiodes comprise several single photodiodes and/or a linear array of photodiodes. The optical grating may be used to differentiate line emission according to their origin, thereby collecting probable failure root cause and/or detecting ageing or wear based on predefined emission patterns. Additionally or alternatively, the additional optical sensor may be a pyrometer allowing to detect at least two different wavelengths, e.g. for measuring black-body radiation. The measured black-body radiation may be used for estimating of a temperature of an anode, a filament, a cathode cup, a bearing, a tube envelope, and/or other tube parts. Also, filters may be used to limit the detection on predefined wavelength intervals. Temperature variation over time may be used as indication of e.g. decreasing heat conduction capability, anode roughening and/or filament evaporation, all corresponding to characteristics of the X-ray tube allowing a prediction of the remaining lifetime of the X-ray tube to be monitored.

According to an embodiment, the optical monitoring system may further comprise a power supply, a communication means and/or an additional power storage unit.

Such an optical monitoring system may be provided as an add-on system, being a stand-alone optical tube supervision system limiting potential interference with the operation of the imaging application while providing tailored results on tube performance. The power supply preferably draws operating power from the normal operation of the X-ray tube. The additional power storage unit may be added for being able to monitor X-ray tube parameters for some time after the X-ray tube has been powered off. This may allow capturing very short usage periods of X-ray tubes as they are routinely used in diagnostic X-ray applications.

According to an embodiment, the optical monitoring system may be configured to use cell-phone-based communication or another wireless communication, such as Bluetooth, WLAN, LoRaWAN, and the like, to transmit said collected signals and/or analysis results to the remote computing device.

The optical monitoring system may be programmed to record measurement data, and/or calculating results based on an analysis of the recorded measurement data, and e.g. call via a mobile phone card a preset number when the result indicates abnormal operation, instability, and/or wear over at least one predefined threshold. Alternatively, the optical monitoring system may communicate on a daily basis with the remote system via a phone card. Instead of using the phone card, the optical monitoring system may use Bluetooth, WLAN, LoRaWAN and the like to communicate with the remote system. In both cases, the optical monitoring system does not depend on the imaging application using the X-ray tube to be monitored.

According to a second aspect, there is provided a unit comprising an X-ray tube and an optical monitoring system according to the first aspect. The at least one optical sensor is arranged within a vacuum holding tube envelope, or outside the tube envelope but inside the radiation-shielding tube housing, or outside the tube envelope and the tube housing.

The placement of the optical sensor may depend on the type of the X-ray tube to be monitored, in particular on a tube envelope design and/or a tube envelope material and/or a radiation shielding and/or, a tube window, polarity, the type of cathode, anode and/or bearings, and the like, as well as on the intended use of the X-ray tube. The optical sensor, in particular a photodiode, may be placed either within the tube envelope or outside the tube envelope.

According to an embodiment, the unit may further comprise at least one light source, the light source and at least one optical sensor being configured to detect depositions inside the tube envelope.

During use of the X-ray tube, depositions, such as metal depositions, on surfaces, such as glass surfaces, may constitute grey filters impacting detected intensity of optical radiation. The light source may be installed to quantify such deposition in transmission or in reflection mode. Alternatively, the deposition may be compensated by measuring at different positions, as shaded and non-shaded. The deposition may also be used as a measure of cumulative tube wear, e.g. as a first signal of a first optical parameter. In particular, metal deposition can also work as wavelength selective filter for the X-ray radiation and can, therefore, be tracked by X-ray spectrum monitoring.

According to an embodiment, the unit may further comprise at least one antenna for wireless communication, wherein the at least one antenna may preferably be accommodated in (plastic) supply-tubes for supplying cooling fluid into the tube housing.

The at least one antenna may be made of thin aerials and may be lead into the supply-tubes. The supply-tubes may be non-conductive so that the radiation of the wireless signals may not be impeded as it would be the case when the aerial would be entirely inside the shielded tube housing. As an alternative, the wireless signals may be coupled onto lines from which the optical monitoring system draws its power.

According to an embodiment, the optical monitoring system may be integrated into the X-ray tube and electrically coupled to a power supply of the X-ray tube.

Such optical monitoring system may be integrated into an imaging application using the X-ray tube and, e.g. electrically coupled to the power supply of the X-ray tube. Such arrangement is less prone to errors, misuse and/or manipulation.

According to a third aspect, there is provided a method for monitoring an X-ray tube. The method comprises the steps of detecting first signals of a first optical parameter and second signals of a second optical parameter by means of at least one optical sensor of an optical monitoring system, wherein the first and second optical parameter are different from each other, and transmitting, by means of a computing unit, said generated measurement data and/or a result of an analysis of measurement data carried out by the computing unit to a remote system external of the X-ray tube. Optionally, the method may further comprise analyzing of the said generated measurement data by means of the computing unit. The method may be at least partly computer-implemented, and may be implemented in software and/or in hardware.

According to an embodiment, the step of transmitting, by means of a computing unit, said generated measurement data may further include collecting the signals, time-stamping the signals and saving the signals.

Time-stamped signals may allow tracing changes in a monitored parameter and drawing conclusions on the remaining lifetime of the X-ray tube based on detected signal in chronical order.

According to a fourth aspect, there is provided a program element configured to be stored on a computing unit of an optical monitoring system according to the first aspect, and configured to cause the optical monitoring system to execute a method according to the third aspect.

It is noted that the above embodiments may be combined with each other irrespective of the aspect involved. Accordingly, the method may be combined with structural features of the system and/or unit of the other aspects and, likewise, the system and/or unit may be combined with features of each other, and may also be combined with features described above with regard to the method. Advantageously, the benefits provided by any of the above aspects and examples equally apply to all of the other aspects and examples and vice versa.

These and other aspects of the present invention will become apparent from and elucidated with reference to the embodiments described hereinafter.

### BRIEF DESCRIPTION OF THE DRAWINGS

Exemplary embodiments of this disclosure will be described in the following drawings.

FIG. 1 shows a schematic view of an exemplary embodiment of an X-ray tube and several positions for sensors of an optical monitoring system for monitoring the X-ray tube.

FIG. 2 shows a schematic illustration of an exemplary embodiment of an optical monitoring system for monitoring an X-ray tube.

FIG. 3 shows a schematic illustration of another exemplary embodiment of an optical monitoring system for monitoring an X-ray tube.

FIG. 4 shows a schematic illustration of another exemplary embodiment of an optical monitoring system for monitoring an X-ray tube.

FIG. 5 shows a flowchart of an exemplary embodiment of a method for monitoring an X-ray tube.

The figures are merely schematic representations and serve only to illustrate embodiments of the invention. Identical or equivalent elements are in principle provided with the same reference signs.

### DETAILED DESCRIPTION OF EMBODIMENTS

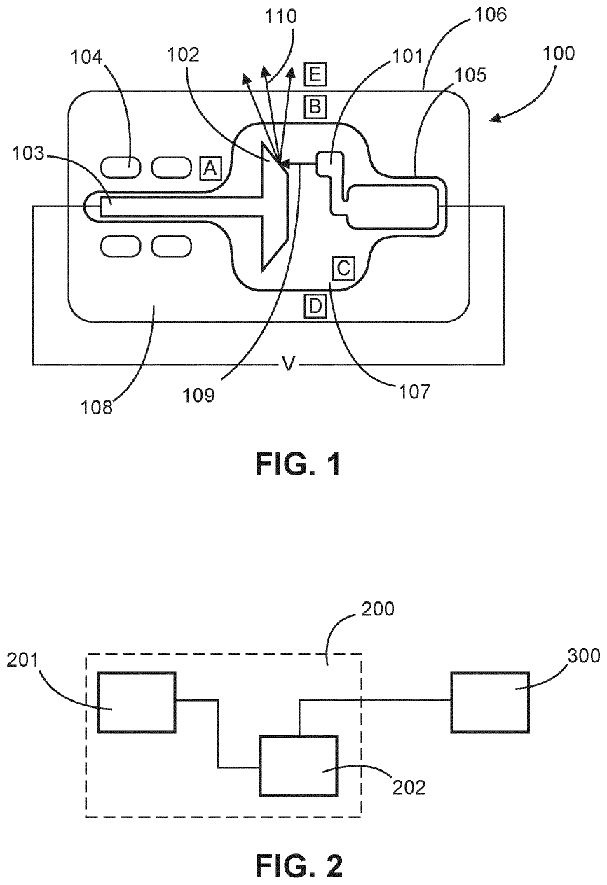

FIG. 1 shows an exemplary embodiment of an X-ray tube 100 in a schematic illustration. The X-ray tube comprises a cathode 101, an anode 102 having an anode rotor 103 and an anode stator 104, a tube envelope 105 forming a vacuum casing, a tube housing 106 forming a shielded casing. The tube envelope 105 encases an evacuated volume 107 forming a vacuum environment for the cathode 101 and the anode 102. The tube housing 106 encases the tube envelope 105 and is filled with an isolating, cooling medium 108. For generating X-ray radiation, the cathode 101 emits electrons in form of an electron beam 109 towards the anode 102, and X-rays 110 are emitted from the anode 102 in the spots where the electron beam 109 hits the anode 102.

During operation, X-ray tube 100 undergoes wearing processes due to which the X-ray tube 100 eventually fails. For detecting deterioration of the X-ray tube 100, the X-ray tube 100 is monitored by an optical monitoring system 200, which will be described in more detail with regard to FIGS. 2 to 4. In FIG. 1, letters A, B, C, D and E mark positions where sensors of the optical monitoring system 200 can be placed for monitoring the X-ray tube 100, depending on parameters to be monitored by the optical monitoring system 200.

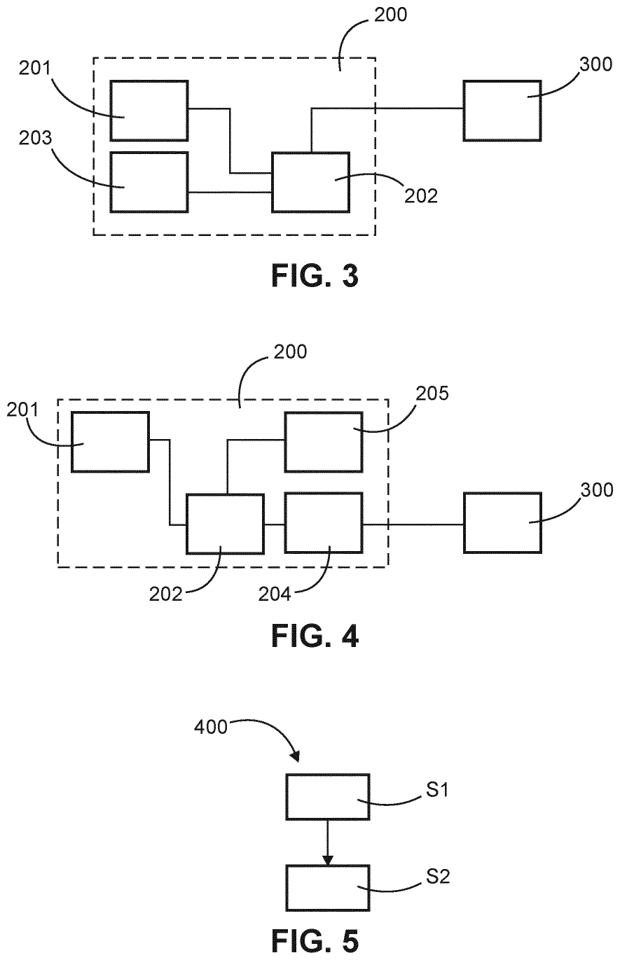

FIG. 2 shows an exemplary embodiment of the optical monitoring system 200 for monitoring the X-ray tube 100. The optical monitoring system 200 comprises an optical sensor 201 and a computing unit 202. FIG. 3 shows another exemplary embodiment of the optical monitoring system 200 for monitoring an X-ray tube 100. The optical monitoring system 200 comprises the optical sensor 201, the computing unit 202 and additionally comprises a non-optical sensor 203.

The optical sensor 201 is configured to detect a first signal from a first optical parameter and a second signal from a second optical parameter as measurement data. The optical parameters are selected from the group comprising plasma glow, discharges, micro-discharges, arcs, x-ray fluorescence, and different line emissions. The optical parameters often are by-products and/or side-effects from the emitted X-ray radiation 110 and/or excitation by the electron beam 109. The optical sensor 202 is, for example, a photodiode, a pyrometer, color filters, optical gratings, preferably in combination with photodiodes, light sources and a combination thereof.

The non-optical sensor 203 is configured to detect signals of at least one non-optical parameter. The non-optical parameter is selected from the group comprising sound or noises, accelerations, positions, electromagnetic signals, X-ray radiation. The non-optical sensor 203 is, for example, a microphone and/or an accelerometer configured to detect sound and sound changes, an accelerometer to detect acceleration and/or position, a field coil configured to detect electromagnetic signals, and/or a radiation sensor configured to monitor a tube output dose and/or spectrum, such as a scintillator plus photodiode, a solid state detector, a MOSFET, or an ionization gauge and a combination thereof.

The computing unit 202 is configured to at least transmit the first and second signals detected from the optical sensor 201 and/or the signals detected by the non-optical sensor 203 to a remote system 300 external from the optical monitoring system 200. Additionally or alternatively, the computing unit 202 may analyze the measurement data and may calculate a result based on the analysis of the measurement data and may transmit the result of an analysis of the measurement data to the remote system 300. For this, the first and second signals detected by the optical sensor 201 and/or the signals detected by the non-optical sensor 203, and collected by the computing unit 202 can be time-stamped.

Further, the computing unit 202 may store the measurement data before transmitting them to the remote system 300. Thus, the computing unit 202 comprises elements for storing the measurement data, elements for analyzing the measurement data and/or elements for transmitting the data and/or the analysis result to the remote system 300. Examples for such elements include a signal processing system, a data processing system, and/or a programmable operating system.

For analyzing the measurement data, the computing unit 202 comprises an X-ray tube lifetime model including at least one predefined pattern for tube status and/or tube aging. Based on this tube lifetime model, the computing unit 202 can calculate the remaining lifetime of the X-ray tube 100 and/or predict its failure. The pattern comprises at least one value of the group of at least one event and/or at least one process and/or at least one predefined range and/or at least one threshold being indicative for tube age and/or tube wear status and/or tube vacuum status. For example, a pattern indicating a nearing filament failure can consist of a predefined difference compared to a value long before the filament failure, in black-body (thermal) radiation and optical radiation from the filament which result from a forming hot-spot. A pattern characteristic of a bearing failure may constitute new emerging line emissions from the liquid metal lubricant of the bearing, which start leaking into the tube vacuum.

Preferably, the pattern comprises a combination of n values and when a combination of k of these values is outside a normal interval, the interval being an n-dimensional volume, this indicates wear and/or instability over a predefined limit, wherein k is equal to or smaller than n. In this case, the computing unit 202 issues a warning, which is communicated to the remote system 300 by a communication unit 204. The communication unit 204 can be separate from the computing unit 202 and coupled to the computing unit 202 as shown in FIG. 4, or the communication unit 204 can be integrally implemented in the computing unit 202, as shown in FIGS. 2 and 3.

The communication between the computing unit 202 and the remote system 300 can be on a regular basis or warning-based. The communication on a regular basis, e.g. a daily basis, can comprise transmitting the measurement data and/or transmitting the result of the analysis of the measurement data. The remote system 300 can be either centrally or locally located, e.g. in at a tube manufacturing plant, a tube service center or in the building in which the X-ray tube 100 is located, for example a hospital. Further, the remote system 300 can be a computer device, such as a laptop, configured to be coupled to the computing unit 202 by a member of an X-ray tube maintenance service.

FIG. 4 shows another exemplary embodiment of the optical monitoring system 200 for monitoring the X-ray tube 100, additionally comprising the separate communication unit 204 and a power supply 205. The power supply 205 is preferably coupled to a power supply of the X-ray tube 100. The power supply 205 can additionally comprise an additional power storage unit (not shown in the FIGS. allowing to monitor the X-ray tube 100 for some time after the X-ray tube 100 has been powered off.

Referring back to FIG. 1, the letter A marks a position for at least one sensor of the optical monitoring system 200 preferably monitoring black-body radiation from a bearing and a back side of the anode 102, outside the tube envelope 105 but inside the tube housing 106. The letter B marks a position for at least one sensor of the optical monitoring system 200 preferably monitoring arcing between the cathode 101 and the anode 102 and/or for black-body radiation from a cathode cup (not shown) and the anode 102. The letter C marks an exemplary position for at least one sensor of the optical monitoring system 200 being arranged inside the tube envelope 105. The letter D marks a position for at least one sensor of the optical monitoring system 200 preferably monitoring arcing and/or black-body radiation from a focal track of the anode 102, and the letter E marks an exemplary position for at least one sensor of the optical monitoring system 200 being arranged outside the tube envelope 105 and outside the tube housing 106.

It should be noted that in case that the optical monitoring system 200 comprises more than one optical and/or non-optical sensor 201, 203, it is possible that these sensors are arranged at different positions inside and/or outside the X-ray tube 100.

FIG. 5 shows a flowchart of an exemplary embodiment of a method for monitoring an X-ray tube. A step S1 comprises detecting first signals of a first optical parameter and second signals of a second optical parameter by means of the at least one optical sensor 201 of the optical monitoring system 200, thereby generating measurement data. The first and second parameters are different from each other. Next, a step S2 comprises transmitting, by means of the computing unit 202 or the communication unit 204, the generated measurement data and/or a result of an analysis of the measurement data carried out by the computing unit 202 to a remote system 300, external from the optical monitoring system 200 and the X-ray tube 100.

### LIST OF REFERENCE SIGNS

100 X-ray tube
101 cathode
102 anode
103 anode rotor
104 anode stator
105 tube envelope
106 tube housing
107 evacuated volume
108 isolating, cooling medium
109 electron beam
110 X-ray radiation
200 optical monitoring sensor
201 optical sensor
202 computing unit
203 non-optical sensor
204 communication unit
205 power supply
300 remote system
400 method
A, B, C, D, E position

1. An optical monitoring system for monitoring an X-ray tube, comprising:
at least one optical sensor configured to detect first signals of a first optical parameter and second signals of a second optical parameter thereby generating measurement data, wherein the first optical parameter and the second optical parameters are by-products and/or side-effects of an electron beam and/or emitted X-ray radiation generated by the X-ray tube, wherein the first optical parameter and the second optical parameters are different from each other; and
a processor configured to analyze the generated measurement data and to transmit the generated measurement data and/or a result of an analysis of the measurement data, to a remote system external of optical monitoring system and the X-ray tube.

2. The optical monitoring system according to claim 1, wherein the first optical parameter and the second optical parameter are selected from the group consisting of plasma glow, discharges, micro-discharges, arcs, x-ray fluorescence, and line emissions.

3. The optical monitoring system according to claim 1, wherein the first optical parameter and the second optical parameter exclude X-ray radiation, and the first signals and the second signals exclude X-ray radiation signals.

4. The optical monitoring system according to claim 1,
wherein an X-ray tube lifetime model comprising at least one predefined pattern for tube status and/or tube aging is stored in the processor, and
wherein the processor is configured to use the stored X-ray tube lifetime model for analyzing the detected first signals of the first optical parameter and analyzing the detected second signals of the second optical parameter.

5. The optical monitoring system according to claim 4, wherein the predefined pattern comprises at least one of: one event, one process, one predefined range, and one threshold being indicative of a tube age, a tube wear status, or a tube vacuum status.

6. The optical monitoring system according to claim 1, wherein the optical sensor is configured to detect line emissions from at least one of the chemical elements B, Si, Na, K, Ca, Sr, Mg, O, N, H, W, Re, Rh, Ga, In, Sn, Mo, Ni, Co, Be, Al, and Fe, as first signal.

7. The optical monitoring system according to claim 1, further comprising at least one non-optical sensor configured to detect signals of at least one non-optical parameter.

8. The optical monitoring system according to claim 1, further comprising a power supply.

9. The optical monitoring system according to claim 1, wherein the optical monitoring system is configured to use cell-phone-based communication or another wireless communication to transmit the collected signals and/or the analysis results to the remote system.

10-13. (canceled)

14. A computer-implemented method for monitoring an X-ray tube, the method comprising:
detecting first signals of a first optical parameter and second signals of a second optical parameter by at least one optical sensor of an optical monitoring system;
generating measurement data based on the detected first signals and the second signals, wherein the first optical parameter and the second optical parameter are different from each other,
analyzing the generated measurement data; and
transmitting the generated measurement data and/or a result of an analysis of measurement data to a remote system external of the X-ray tube and of the optical monitoring system.

15. The method according to claim 14, wherein collecting the first signals of the first optical parameter and the second signals of the second optical parameter includes time-stamping the signals and saving the signals.

16. (canceled)
